(19) United States
(12) Patent Application Publication
(10) Pub. No.: US 2008/0213655 A1
(43) Pub. Date: Sep. 4, 2008

(54) SAFE LITHIUM ION BATTERY

(75) Inventors: Richard Yang, Dongguan (CN); Tiger Fu, Dongguan (CN)

Correspondence Address: ERIC CHAN, 42 PIN OAKS DRIVE, PHOENIXVILLE, PA, 19460, US

(73) Assignee: Dongguan NewPower Electric Science and Technology Co., Ltd., Dongguan (CN)

(21) Appl. No.: 11/759,248

(22) Filed: Jun. 7, 2007

(30) Foreign Application Priority Data
Mar. 1, 2007 (CN) 2007200489761

(51) Int. Cl. H01M 2/02; H01M 4/82

(52) U.S. Cl. 429/164; 29/623.2

(57) ABSTRACT

The present invention discloses a safe lithium ion battery to solve the short circuit problem of short circuit caused by metal grains produced during the production of the battery on the neck of the lithium ion battery. The lithium ion battery comprises a cylindrical shell, a battery cover, an anode, a membrane, a cathode, an organic electrolyte, and a concave is provided on the round neck of the cylindrical shell, wherein a round tape is provided on the surface of the inner wall of the concave round neck. The lithium ion battery may completely solve the problem of metal grain produced during the production of the neck of the battery shell falling into the shell causing short circuit. It may also solve the problem of damage on the neck of the battery shell during the production of the battery, and short circuit caused by metal grain produced in the using of the battery.

### BACKGROUND OF THE INVENTION

The present invention relates to a lithium ion battery, more particularly, relates to a safe lithium ion battery that may prevent short circuit caused by metal grains produced during the production of the battery on the neck of the lithium ion battery. The present invention also relates the method to produce the lithium ion battery of the present invention.

Since the birth of lithium ion battery in the 90s of 20th century, it has been developed rapidly because of its high power density, high working voltage, long life cycle, steady electrochemical characteristics, fast chargeable, wide range of working temperature, good charge keeping ability, no pollution, no memory effects etc. The battery is widely applied in the fields of production, everyday life, and scientific research etc. Lithium ion battery has made great contribution to mobile phones, notebook computers, digital cameras, and miniaturization of MP3 players, further; it will be applied in national defence and space exploring.

Lithium ion battery consists of anode, membrane, cathode, organic electrolyte, and battery shell. The anode is often made of LiCoO2, LiNiO2, LiMnO2, etc., the septum is often made of single or multi layer membrane with plurality of minor holes made from (of) PE, PP etc., the cathode is often made of graphite carbon material, amorphous carbon material etc. Since the electric potential of the cathode of the lithium ion battery is similar to lithium, it is quite active, it is unsteady in water, therefore, non-hydrated, and non-proton organic solvent must be used as the carrier for lithium ion. Organic electrolyte mainly comprises unitary, binary or ternary mixed solvent formed by ethylene carbonate, dimethyl carbonate, diethyl carbonate, ethyl methyl carbonate, etc.

Lithium ion battery is widely applied, the primary examination target of lithium ion battery is safety.

To ensure the safety of lithium ion battery, plurality of actions were taken:

(1) Membrane Auto Cut-Off Protection at 135° C.
Celgard2300PP-PE-PP triple multiple membrane were employed. When the temperature of the battery reaches 120° C., the PE membrane hole on both sides of said multiple membrane will close to increase the inner resistance of the battery, thus to slowdown the rising of the temperature in the battery. When the temperature reaches 135° C., said PP membrane holes will close, the inside of the battery is open circuit, thus the rising of temperature of the battery is stopped to ensure the safety of the battery.

(2) Filling Additive into the Electrolyte
When the battery is over charged, that is the voltage is higher than 4.2 v, the electric liquid additive polymerize with other materials in the electric liquid, the inner resistance of the battery will increase, open circuit are formed in the battery, thus the temperature will not rise.

(3) Multiple Structure of the Battery Cover
The battery cover employs score blast prevention structure. When the temperature of the battery rises, part of the air generated during the active in the battery inflates. The pressure within the battery increases, when the pressure reaches a certain degree, the score is torn, thus to deflate.

(4) Misuse in Various Environments
Perform various misuse experiments, such as, short circuit, over charged, puncture, board impaction, burning etc. to check the safety of the battery. Meanwhile, perform temperature impact experiments and mechanics performance experiments of shaking, falling, impaction, thus to check the performance of the battery in real application environments.

The actions mentioned above may increase the safety of lithium battery. However, they can not solve the safety problems of lithium ion battery on the most basic point. One kind of cylindrical shell battery with a concave neck on the upper part of the shell, while forming this neck structure, the process may produce some metal grains. If the metal grain breaks the membrane of the lithium ion battery, short circuit will occur. As reported by the press, the notebook computer battery recalling event caused lots of loss to Sony, the main issue of the fire is the metal grain in the battery broke the membrane and caused short circuit.

### BRIEF SUMMARY OF THE INVENTION

The object of the present invention is to solve the problems described above, to provide a safe lithium ion battery that may prevent short circuit caused by metal grains produced during the production of the battery on the neck of the lithium ion battery. The present invention also relates to the lithium ion battery produced in accordance with the method in the present invention.

To achieve the object describe above, the technical solution of the present invention is, to provide a method for producing safe lithium ion battery, the battery is with a cylindrical shell, and a concave is provided on the round neck of the shell, the method comprising the steps of: preparing materials of anode, membrane, cathode, and electrolyte; forming the shell of the battery; depositing the above materials inside the shell; then closing over the cover; wherein when forming the shell, further comprises the step of allocating a round tape on the surface of the inner wall of the concave round neck.

Preferably, the width of the round tape is equal to or larger than the width of the neck portion, the tape can be a propylene tape, and the thickness is around 0.025-0.035 mm.

The present invention further provides a safe lithium ion battery, comprises a cylindrical shell, a battery cover, an anode, a membrane, a cathode, an organic electrolyte, and a concave is provided on the round neck of the cylindrical shell, wherein a round tape is provided on the surface of the inner wall of the concave round neck.

The benefits of implementing the present invention is: since the tape is provided on the surface of the inner wall of the concave round neck, the metal grain may stick to the tape instead of falling into the shell, thus to completely solve the defect of metal grain falling into the shell and causing short circuit that caused by metal grains produced during the production of the battery on the neck of the lithium ion battery. It may also solve the defect of damage on the neck of the battery shell during manufacture of the battery, and short circuit caused by metal grain created in the using of the battery.

### BRIEF DESCRIPTION OF THE DRAWINGS

FIG. 1 is the sectional view of the forming of shell of the new lithium ion battery, in accordance with the present invention;

FIG. 2 is the sectional view after the forming of the neck of the lithium ion battery shell shown in FIG. 1;

FIG. 3 is the top view of FIG. 2.

### DETAILED DESCRIPTION OF THE INVENTION

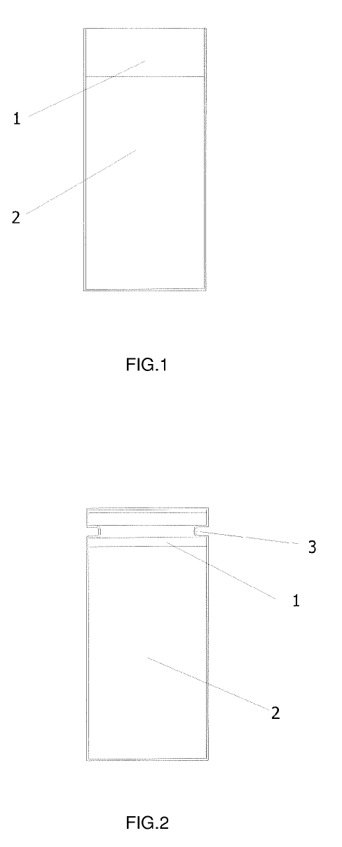

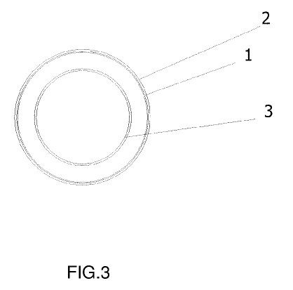

Referring to FIGS. 1, 2 and 3, a cylindrical safe lithium ion battery is provided, before forming said battery, a round tape 1 may be fixed on the surface of the inner wall of the neck 3 of the battery shell 2, plastic deformation during the forming of the neck 3 of the battery shell, a small amount of metal grain falls. Although some of the metal grains do not come off completely, however, it is damaged, thus they will fall off easily during later on usage. If these already fell or falling metal grains remain inside the battery, they will break the membrane of the battery causing short circuit. However, the round tape 1 will cement the metal grains produced during the production, in addition, it will cement the metal grains produced during usage, thus to prevent short circuit caused by metal grains breaking the membrane.

The width of said round tape 1 may be greater than or equals to the width of the neck, tapes of propylene material are often employed. The thickness of said tape may be chosen between 0.025-0.035 mm, and the width of the tape may be 11 mm.

The thickness of the tape is often about 0.031 mm; said tape 1 may be attached to the inner surface of the shell 2 by adhering or heat conglutinating.

What is claimed is:

1. A method for producing safe lithium ion battery which having a cylindrical shell and a concave allocating on the round neck of the shell, comprising the steps of: preparing materials of anode, membrane, cathode, and electrolyte; forming the shell of the battery; depositing the above materials inside the shell; then closing over the cover; wherein in the step of forming further comprises the step of allocating a round tape on the surface of the inner wall of the concave round neck; and the width of the round tape is equal to or larger than the width of the neck; the tape is a propylene tape, and the thickness is about 0.025˜0.035 mm.

2. The method as in claim 1, wherein the width of the round tape is about 11 mm, the thickness of the tape is about 0.031 mm.

3. A safe lithium ion battery comprising a cylindrical shell, a battery cover, an anode, a membrane, a cathode, an organic electrolyte, and a concave is provided on the round neck of the cylindrical shell, wherein a round tape is provided on the surface of the inner wall of the concave round neck.

4. The safe lithium ion battery as in claim 3, wherein the width of said round tape may be greater than or equals to the width of the neck, tapes of propylene material are often employed; the thickness of said tape is between about 0.025-0.035 mm.

5. The safe lithium ion battery as in claim 4, wherein the width of said tape is about 11 mm, the thickness of said tape is about 0.031 mm.
